(19) United States
(12) Patent Application Publication
(10) Pub. No.: US 2016/0221412 A1
(43) Pub. Date: Aug. 4, 2016

(54) AIR CONDITIONING DEVICE FOR A MOTOR VEHICLE WITH DUAL STREAM INCORPORATING A HEAT DISTRIBUTOR

(71) Applicant: VALEO SYSTEMS THERMIQUES, Le Mesnil Saint-Denis (FR)

(72) Inventors: Didier LOUP, Maurepas (FR); Amanda MARTINELL, Neauphle-Le-Château (FR); Fabrice AILLOUD, Guyancourt (FR); Philippe VINCENT, Givrand (FR)

(73) Assignee: Valeo Systemes Thermiques, Le Mesnil Saint Denis (FR)

(21) Appl. No.: 15/021,728

(22) PCT Filed: Sep. 9, 2014
(86) PCT No.: PCT/EP2014/069201

§ 371 Date: Mar. 14, 2016

(30) Foreign Application Priority Data
Sep. 19, 2013 (FR) 1358992

(51) Int. Cl. B60H 1/00

(52) U.S. Cl. CPC B60H 1/00064; B60H 1/00678; B60H 2001/00135; B60H 2001/00714; B60H 2001/00192; B60H 2001/00185

(57) ABSTRACT

The invention relates to a device (1) with a dual air conditioning stream for a motor vehicle, comprising a chamber (2) containing an evaporator (3) and a radiator (4). A lower air stream admitted via a lower inlet (6) passes in succession through a lower portion of the evaporator (3) and of the radiator (4) before being discharged via a lower outlet (7). An upper air stream admitted via an upper air inlet (9) passes in succession through an upper portion of the evaporator (3) and of the radiator (4) before being discharged via an upper outlet (12, 13, 14). The device according to the invention comprises a first distribution flap (17) situated between the evaporator (3) and the radiator (4) and a second distribution flap (18) situated between the radiator (4) and the air outlets (12, 13, 14). Each flap divides the lower stream from the upper stream having an edge running along one face of the radiator (4) while at the same time being moveable between an upper position and a lower position.

The invention concerns a motor vehicle air conditioning device including means for heating, ventilating and cooling the air in the passenger compartment, notably to regulate the temperature in the passenger compartment and to demist its windows.

### BACKGROUND OF THE INVENTION

Such a device is generally installed between the front seats and the dashboard of the vehicle that it equips. It includes a casing delimiting an internal enclosure having a plurality of air inlets and a plurality of air outlets, this enclosure enclosing an evaporator for cooling the air and a radiator for heating it.

Various systems of flaps and other adjustable shutter means are also provided for adjusting the flowrates of air in the evaporator, in the radiator and in the air inlets and outlets, so as to regulate the temperature of the treated air.

Such a device is advantageously of the double air stream type: a so-called upper air stream enters and leaves via inlets and outlets situated in an upper portion of the enclosure and a so-called lower air stream enters and leaves via inlets and outlets situated in a lower portion of the enclosure.

Two distinct blower systems force the circulation of the upper and lower streams in an independent manner so that the upper stream passes through the upper portion of the evaporator and the radiator and the lower stream passes through the lower portions of those elements.

The upper stream makes it possible to regulate the temperature in the upper portion of the passenger compartment and to demist the front windows of the vehicle, for example, while the lower stream makes it possible to regulate the temperature in the lower portion of the passenger compartment, for example.

The streams can moreover be divided laterally: in this case, the enclosure includes a central vertically oriented internal wall that divides it into two portions that are symmetrical with respect to that wall. The upper stream then includes a left-hand portion and a right-hand portion for regulating the temperature of the left-hand and right-hand parts respectively of the upper portion of the passenger compartment. The same goes for the lower stream.

In such a system, the upper stream passes through the upper half of the radiator and the lower stream passes through the lower half of the radiator, which represents a penalty if the users deactivate one of the streams: the heating power of the remaining stream is then limited to half the heating power that can be supplied by the radiator.

### OBJECT OF THE INVENTION

The object of the invention is to propose a solution to remedy this disadvantage.

### SUMMARY OF THE INVENTION

To this end, the invention consists in a double stream motor vehicle air conditioning device including an enclosure enclosing an evaporator and a radiator, arranged so that a lower air stream admitted via a lower inlet of the enclosure passes successively through a lower portion of the evaporator and of the radiator before being discharged via a lower outlet of the enclosure, and an upper air stream admitted via at least one upper air inlet of the enclosure passes successively through an upper portion of the evaporator and of the radiator before being discharged via an upper outlet of the enclosure, this device including a first distribution flap situated between the evaporator and the radiator and a second distribution flap situated between the radiator and at least one air outlet, each distribution flap being a rotary flap separating the lower stream from the upper stream by virtue of having an edge extending along a face of the radiator whilst being mobile between an upper position and a lower position to adjust the distribution of the flow sections of the lower stream and the upper stream through the radiator.

When the distribution flaps are in a high position, the area of the section of the radiator through which the lower stream passes is significantly greater than the area of the section of the radiator through which the upper stream passes. When the flaps are in a low position, it is to the contrary the upper stream that passes through the radiator section having the greater area. The invention therefore makes it possible to distribute the heating effect between the upper stream and the lower stream.

The invention also concerns a device as defined above including a third flap situated between the upper air inlets and the lower air inlets on the one hand and the evaporator on the other hand, this third flap being mobile between a deployed position in which it separates the stream admitted via the upper inlet from the stream admitted via the lower inlet and a retracted position of free circulation between the upper air inlet and the lower air inlet and the evaporator.

The invention also concerns a device as defined above including an internal wall dividing the enclosure into a left-hand portion and a right-hand portion and including a first distribution flap on the left-hand side and a first distribution flap on the right-hand side that are mounted symmetrically on respective opposite sides of this wall and a second distribution flap on the left-hand side and a second distribution flap on the right-hand side that are mounted symmetrically on respective opposite sides of the central wall.

The invention also concerns a device as defined above wherein the enclosure includes a left-hand extension and a right-hand extension each delimiting a channel bypassing the lower portion of the radiator, these left-hand and right-hand extensions respectively discharging into the left-hand portion and into the right-hand portion of a region situated on the downstream side of the radiator, each extension incorporating a flowrate regulator flap so as to establish in the left-hand portion and in the right-hand portion of the region on the downstream side of the radiator a left-hand stream and a right-hand stream having different temperatures.

The invention also concerns a device as defined above wherein the extensions extend under the radiator when the device is in place in a vehicle.

The invention also concerns a device as defined above wherein the extensions extend laterally with respect to the lower portion of the radiator when the device is in place in a vehicle.

### BRIEF DESCRIPTION OF THE FIGURES

FIG. 1 is a lateral sectional view of the left-hand portion of the air conditioning device in accordance with the invention in a normal configuration;

FIG. 2 is a lateral sectional view of the left-hand portion of the air conditioning device in accordance with the invention in a configuration favoring heating of the lower stream;

FIG. 3 is a lateral sectional view of the left-hand portion of the air conditioning device in accordance with the invention operating in a single-stream mode;

FIG. 4 is a lateral sectional view of the left-hand portion of the air conditioning device in accordance with a first variant of the invention equipped with a mixer unit placed in a low position relative to the radiator;

FIG. 5 is a lateral sectional view of the left-hand portion of the air conditioning device in accordance with a second variant of the invention equipped with air mixer units offset laterally relative to the radiator.

### DETAILED DESCRIPTION OF THE INVENTION

The basic idea of the invention is to modulate the flow section of the lower stream and of the upper stream through the radiator so as notably to increase the flow section for one of the streams when the other stream is deactivated.

The conditioning device 1 in accordance with the invention that is represented in the figures includes a casing 2 delimiting an internal enclosure that encloses an evaporator 3 for cooling the air and a radiator 4 for heating it.

This casing 2 includes in its lower region a common lower air inlet 6 situated on the upstream side of the evaporator 3, a lower air outlet 7 on the left-hand side situated on the downstream side of the radiator 4, and a lower air outlet on the right-hand side. The air of the lower stream is therefore admitted via the inlet 6 before being divided and passing successively through a lower portion of the evaporator 3 and a lower portion of the radiator 4 to be discharged via the lower outlets on the left-hand side and on the right-hand side. The circulation of the lower stream is forced by a fan system that cannot be seen in the figures.

For its part, the circulation of the upper stream is forced by a centrifugal fan 8 that feeds a common upper inlet 9 of the casing 2. This upper stream is then divided to pass successively through the left-hand and right-hand parts of an upper portion of the evaporator 3 and of the radiator 4 before it reaches the left-hand and right-hand portions of a top cavity 11 of the casing.

The radiator 4 and the evaporator 3 are both of parallelepiped shape and extend more or less vertically one in front of the other when the device is in place, the radiator being the element that is farthest forward in relation to the direction of forward movement of the vehicle. The upper and lower air streams follow horizontal paths when they pass successively through these elements.

The top cavity 11 corresponds to the top region of the internal enclosure that the casing 2 delimits: it extends over the assembly formed by the radiator 4 and the evaporator 3 through which the lower stream and the upper stream circulate.

The enclosure 2 delimits on the one hand a duct for circulation of the lower and upper streams that extends from the inlets 6, 9 and encloses the evaporator 3 and the radiator 4 and on the other hand the top cavity 11 that is situated above this duct and communicates with this duct at the level of a region situated on the downstream side of the radiator 4.

The duct and the top cavity are each divided into a left-hand portion and a right-hand portion by a central wall of the enclosure 2 to divide the lower stream and the upper stream. This central wall 15 is seen in FIG. 4.

The top cavity 11 includes three upper outlets on the left-hand side and three upper outlets on the right-hand side symmetrical to one another with respect to the central wall. An upper outlet 12 on the left-hand side is substantially contiguous with and above the lower outlet 7 on the left-hand side. This upper outlet 12 on the left-hand side is therefore situated in line with the natural path of the upper stream on the left-hand side passing successively through the left-hand part of the top portion of the evaporator 3 and of the radiator 4.

The other two upper outlets 13 and 14 on the left-hand side are produced in the corresponding wall above the casing 2 and are situated facing the intermediate region 16 extending between the evaporator 3 and the radiator 4.

The air of the upper stream on the left-hand side introduced into the left-hand portion of the top cavity is therefore discharged via the upper outlets 12, 13, 14 on the left-hand side. In practice, the lower outlet 7 on the left-hand side corresponds to the region of the feet of the left-hand rear passenger in the passenger compartment and the upper outlet 12 on the left-hand side corresponds to other ventilation of the left-hand rear portion of the passenger compartment. The upper outlets 13 and 14 on the left-hand side respectively correspond to left-hand front ventilation and demisting of the windows situated in the left-hand front portion of the passenger compartment.

Clearly, the general structure of the device is symmetrical with respect to the vertical central wall dividing the enclosure into a left-hand portion and a right-hand portion, and so the right-hand outlets of the device are notably symmetrical to the left-hand outlets defined above with respect to this median plane.

There are therefore a lower stream on the right-hand side and a upper stream on the right-hand side that circulate in the right-hand portion of the enclosure in a similar manner to the upper and lower streams on the left-hand side and that are discharged at the level of the lower and upper outlets on the right-hand side of the enclosure.

As can be seen in the figures, the device in accordance with the invention is equipped with first and second flaps 17, 18 on the left-hand side that separate the lower stream on the left-hand side from the upper stream on the left-hand side. These two distribution flaps are respectively mounted on the upstream side and on the downstream side of the radiator 4 in the left-hand portion of the duct through which the lower and upper streams pass.

These two left-hand distribution flaps are rotary flaps of globally horizontal orientation situated substantially at mid-height relative to the radiator.

The first distribution flap 17 on the left-hand side is therefore mounted to rotate about a horizontal axis 19 oriented transversely relative to the lower stream, this axis 19 extending along a face of the evaporator 3 that is its downstream face with respect to the streams of air that pass through it.

The distribution flap 17 on the left-hand side has a rectangular general shape the axis 19 of which coincides with one of the edges. The edge opposite that with the axis 19 extends along a face of the radiator 4 that is its upstream face in relation to the lower and upper streams. This edge is equipped with a seal ensuring that it remains in contact with the upstream face of the radiator 4 in any angular position of the flap.

The second distribution flap on the left-hand side, namely the flap 18, is mounted symmetrically with the left-hand flap 17 with respect to a transverse plane corresponding to the general orientation of the radiator 4. This left-hand flap 18 is therefore mounted to rotate about a horizontal axis 21 transversely oriented with respect to the air streams, this axis 21 being situated substantially half-way between the radiator 4 and the outlets 7 and 12. The axis 21 is situated substantially at mid-height relative to the radiator 4 and relative to the left-hand outlets 7 and 12.

The second distribution flap 18 on the left-hand side also has a generally rectangular shape one edge of which coincides with its rotation axis 21. The edge opposite that with the axis 21 is also equipped with a seal in order to remain pressed against the downstream face of the radiator 4 in any angular position of this second flap.

In the FIG. 1 configuration, the first and second flaps 17 and 18 on the left-hand side occupy median positions: they extend in line with each other in a plane situated substantially at the mid-height of the radiator 4. The upper stream and the lower stream on the left-hand side respectively pass through an upper portion and a lower portion of the left-hand part of the radiator 4 which then have substantially identical areas.

Under these conditions, the upper stream and the lower stream on the left-hand side receive the same amount of heat when they pass through the radiator so that they are heated in an equivalent manner, which corresponds to a situation in which the heating demand at the level of the upper outlets on the left-hand side and at the level of the lower outlets on the left-hand side is substantially identical.

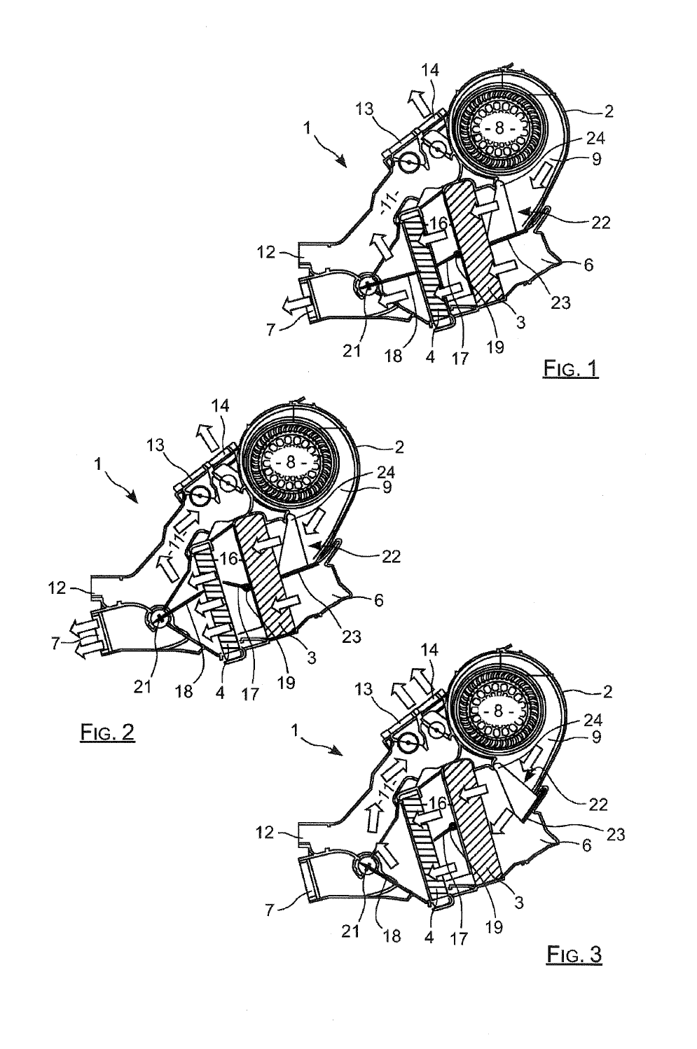

In the FIG. 2 configuration, the two flaps on the left-hand side are in a high position: the mobile edges of these left-hand flaps are situated substantially at two thirds of the height of the radiator 4. The area of the lower portion of the left-hand part of the radiator, through which the lower stream on the left-hand side passes, is therefore approximately twice the area of the upper portion of this left-hand part, so that the upper portion on the left-hand side receives approximately two thirds less heat than the lower stream on the left-hand side.

This configuration corresponds to a situation in which the hot air demand is twice as great at the level of the lower outlet on the left-hand side than at the level of the upper outlets on the left-hand side.

In other words, the left-hand distribution flaps 17 and 18 make it possible to adjust the flow section of the two streams on the left-hand side as a function of the heat demand at the level of the lower outlet and the upper outlets on the left-hand side.

The device being symmetrical with respect to the central wall 15, it includes in its right-hand part, not shown, a first distribution flap and a second distribution flap on the right-hand side that are symmetrical to the flaps 17 and 18 with respect to this wall 15.

These two flaps, which cannot be seen in the figures, and which equip the right-hand portion, are actuated independently of the left-hand distribution flaps 17 and 18 to divide the radiator area through which the lower stream and the upper stream on the right-hand side pass in a manner that is completely independent of the distribution of the area through which the lower stream and the upper stream on the left-hand side pass, which is conditioned exclusively by the positions of the flaps 17 and 18.

In a complementary way, the device in accordance with the invention is further equipped with a third stream distribution flap 22 which is situated on the upstream side of the evaporator 3, between that evaporator 3 and the lower and upper inlets 6 and 9. This third flap 22 is a single flap that is common to the right-hand portion and to the left-hand portion of the enclosure, the central wall being open in the region of this third flap 22.

This third flap 22 is a rotary flap including a rectangular main wall 23 that is connected by lateral partitions to its rotation axis 24 which is parallel to and offset relative to this main wall 23.

As can be seen in the figures, this third distribution flap 22 is therefore mobile between a deployed position in which it extends perpendicularly to and substantially at the mid-height of the evaporator 3, as in FIGS. 1 and 2, and a retracted position corresponding to that of FIG. 3.

In the deployed position, the flap 22 separates the upper stream from the fan 8 introduced via the upper inlet 9 from the lower stream admitted via the lower inlet 6 so that these two streams respectively pass through an upper portion and a lower portion of the evaporator 3 with no risk of them mixing.

In the retracted position, the flap 22 allows the two inlets 6 and 9 to communicate freely with the whole of the flow section of the evaporator 3. This configuration, which notably corresponds to FIG. 3, makes it possible to increase the flow section of the upper stream through the evaporator 3 and through the radiator 4 when the lower stream is deactivated, that is to say when there is no heat demand either at the level of the lower outlets on the left-hand side or on the right-hand side.

In other words, in the event of deactivation of the lower stream, the third flap makes it possible to ensure that the upper stream passes through all of the section of the evaporator 3 and all of the section of the radiator 4 so as to have the benefit of substantially twice the heating or cooling power.

In this case, and as shown in FIG. 3, the second distribution flap 18 on the left-hand side is lowered to shut off the lower outlet 7 in order to ensure that the whole of the left-hand stream coming from the radiator 4 is injected into the left-hand portion of the top cavity 11 to be discharged at the level of the upper outlets 12, 13 and 14 on the left-hand side. The same applies to the second flap on the right-hand side, which cannot be seen in the figures.

The third flap 23 therefore makes it possible to benefit from the complete section of the radiator when the system is operating in the single-stream mode in order to increase the amount of heat transferred.

In the event of deactivation of the upper stream, an analogous configuration may be adopted so that all of the area of the evaporator and all of the area of the radiator have only the lower stream pass through them. It then suffices to retract the third flap 22 and to place the second flap on the left-hand side and on the right-hand side in the highest position in order for all of the stream that has passed through the radiator to be directed toward the lower outlets.

In a variant shown in FIG. 4, the lower portion of the enclosure 2 includes a left-hand lateral extension and a right-hand lateral extension 27 making it possible for the lower air streams on the left-hand side and on the right-hand side partly to bypass the radiator 4 instead of passing through it. The left-hand extension 26 is equipped with a butterfly type left-hand regulation flap 28 making it possible regulate the air stream bypassing the radiator and in an analogous manner the right-hand extension also includes a right-hand butterfly flap 29 for regulating the flowrate.

Under these conditions, and as can be seen in FIG. 4, some of the air of the lower stream on the left-hand side passes through the radiator 4 and another portion of this lower stream on the left-hand side bled off in the left-hand portion of the intermediate region 16 bypasses the radiator 4. These two portions are joined in the left-hand part of the lower portion of the region downstream of the radiator 4.

Accordingly, opening the left-hand regulation flap 28 makes it possible to lower the temperature of the air of the lower, stream on the left-hand side that is discharged into the lower outlet 7 on the left-hand side and, contrariwise, closing this flap 28 makes it possible to increase this temperature. This has no impact on the temperature of the air of the upper stream on the left-hand side that is conditioned by the position of the distribution flaps 17 and 18.

In the same manner, the right-hand regulation flap 29 makes it possible to modify the temperature of the lower stream on the right-hand side that is discharged at the level of the lower outlet 10 on the right-hand side without impact on the temperature of the upper stream on the right-hand side.

In other words, thanks to the lateral extensions 26 and 27 with their internal regulation flaps 28 and 29, the device makes it possible to deliver four streams of air at four different temperatures at the level of the lower and upper outlets on the left-hand side and on the right-hand side, which makes it possible to have four areas at different temperatures in the passenger compartment.

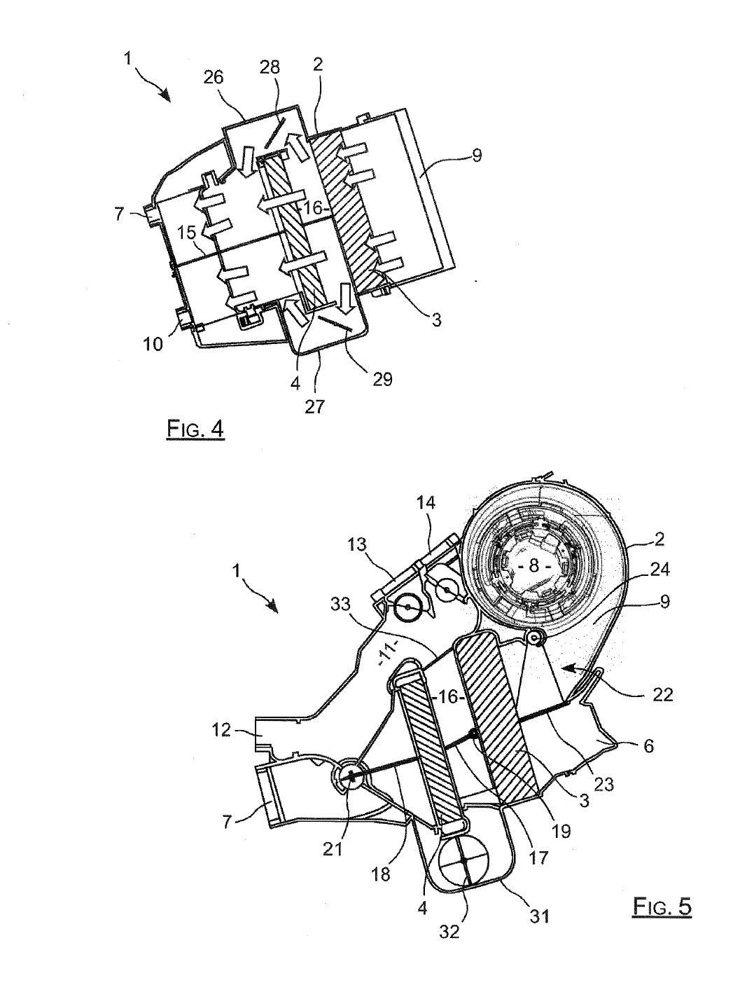

In another variant of the invention which is shown in FIG. 5, the enclosure 2 is provided with extensions of the same type as the lateral extensions 26 and 27 but which are placed under the lower edge of the radiator 4 to bypass it in an analogous manner to the right-hand portion and the left-hand portion.

Just as in the first variant from FIG. 4, each of the two extensions of the variant from FIG. 5 includes a flowrate regulation flap, these flaps making it possible to adjust the flowrate of cool air passing through each extension to obtain different temperatures at the level of the lower outlets on the left-hand side and on the right-hand side.

FIG. 5 shows one of these extensions 31 incorporating a regulation flap 32 of the butterfly flap type.

The choice of lateral extensions as in FIG. 4 or of lower extensions as in the variant from FIG. 5 is conditioned by the space available in the vehicle to be equipped with the device in accordance with the invention.

Moreover, it is possible to produce a mixing of air at the level of the upper streams on the left-hand side and on the right-hand side by replacing the wall 33 that divides the intermediate region 16 and the top cavity 11 with two mixer flaps, namely a left-hand flap and a right-hand flap. Such mixer flaps make it possible to admit into the top cavity a mixture of air coming from the radiator 4 and air coming from the evaporator 3 and diverted toward the top cavity directly at the level of these flaps.

1. A double stream motor vehicle air conditioning device, comprising:
an enclosure enclosing an evaporator and a radiator the enclosure being arranged so that:
a lower air stream admitted via a lower inlet of the enclosure passes successively through a lower portion of the evaporator and of the radiator before being discharged via a lower outlet of the enclosure, and
an upper air stream admitted via an upper air inlet of the enclosure passes successively through an upper portion of the evaporator and of the radiator before being discharged via at least one upper outlet of the enclosure;
a first distribution flap situated between the evaporator and the radiator; and
a second distribution flap situated between the radiator and at least one air outlet,
each of the first and second distribution flaps being a rotary flap separating the lower stream from the upper stream by virtue of having an edge extending along a face of the radiator whilst being mobile between an upper position and a lower position to adjust the distribution of the flow sections of the lower stream and the upper stream through the radiator.

2. The device as claimed in claim 1, further comprising a third flap situated between the upper air inlets and the lower air inlets on the one hand and the evaporator on the other hand, this third flap being mobile between a deployed position in which the third flap separates the stream admitted via the upper inlet from the stream admitted via the lower inlet and a retracted position of free circulation between the upper air inlet and the lower air inlet and the evaporator.

3. The device as claimed in claim 1, further comprising an internal wall dividing the enclosure into a left-hand portion and a right-hand portion and including a first distribution flap on the left-hand side and a first distribution flap on the right-hand side that are mounted symmetrically on respective opposite sides of this wall, and a second distribution flap on the left-hand side and a second distribution flap on the right-hand side that are mounted symmetrically on respective opposite sides of the central wall.

4. The device as claimed in claim 3, wherein the enclosure includes a left-hand extension and a right-hand extension, each delimiting a channel bypassing the lower portion of the radiator, the left-hand and right-hand extensions respectively discharging into the left-hand portion and into the right-hand portion of a region situated on the downstream side of the radiator, each extension incorporating a flowrate regulator flap so as to establish in the left-hand portion and in the right-hand portion of the region downstream of the radiator, a left-hand stream and a right-hand stream having different temperatures.

5. The device as claimed in claim 4, wherein the extensions extend under the radiator when the device is in place in a vehicle.

6. The device as claimed in claim 4, wherein the extensions extend laterally with respect to the lower portion of the radiator when the device is in place in a vehicle.
